(19) United States
(12) Patent Application Publication
(10) Pub. No.: US 2008/0166631 A1
(43) Pub. Date: Jul. 10, 2008

(54) FLAT ORGANIC ELECTROLYTE SECONDARY BATTERY

(76) Inventors: Tadayoshi TAKAHASHI, Osaka (JP); Hiroyuki AKIYA, Kyoto (JP); Akira KAKINUMA, Osaka (JP); Kanji KAWAKAMI, Osaka (JP); Tuyoshi YANAGIMOTO, Osaka (JP)

Correspondence Address: MCDERMOTT WILL & EMERY LLP, 600 13TH STREET, NW, WASHINGTON, DC, 20005-3096, US

(21) Appl. No.: 12/052,479

(22) Filed: Mar. 20, 2008

Related U.S. Application Data
(63) Continuation of application No. PCT/JP2006/318565, filed on Sep. 20, 2006.

(30) Foreign Application Priority Data
Sep. 21, 2005 (JP) 2005-273349

(51) Int. Cl. H01M 2/08; H01M 4/48

(52) U.S. Cl. 429/185; 429/162; 429/231.1; 429/231.5

(57) ABSTRACT

A flat organic electrolyte secondary battery includes a negative electrode, a positive electrode, an organic electrolyte, a separator, a sealing plate, and a positive electrode can gasket. The negative electrode includes an oxide capable of reversibly absorbing and desorbing lithium ions as a negative electrode active material. The sealing plate is in contact with the negative electrode and serves as a negative electrode terminal. The gasket is interposed between the positive electrode can and the sealing plate. The gasket is composed of tetrafluoroethylene-perfluoroalkyl vinyl ether copolymer resin having a heat deformation temperature of 70° C. or more at a load of 0.45 MPa and a heat deformation temperature of 60° C. or less at a load of 1.82 MPa.

### TECHNICAL FIELD

The invention relates to a flat organic electrolyte secondary battery that is stable even under a hot and humid environment and is excellent in long-term reliability and high-load discharge performance.

### BACKGROUND ART

A pressure sensor inside a tire is used in a harsh condition such as a hot and humid environment having a temperature of higher than 85° C. and a humidity of about 90%. There is a demand for batteries that can be used in such special applications and can deliver large current. One candidate for such batteries is organic electrolyte batteries, and they are being studied and developed extensively.

The optimum shape of organic electrolyte batteries is a flat shape (button, coin, or flat and prismatic shape) in view of necessary discharge capacity, size, mountability, costs, etc. Flat organic electrolyte batteries are sealed by crimping. Since such a sealing method is inferior in gas tightness to other methods such as laser seal and glass hermetic seal, it may cause a degradation of battery performance or electrolyte leakage in a high-temperature atmosphere of more than 60° C. due to the load of thermal shock.

In order to improve the heat resistance of flat organic electrolyte batteries that use a light metal such as lithium, sodium, or magnesium, or an alloy thereof in the negative electrode, various proposals have been made. For example, Japanese Laid-Open Patent Publication No. Hei 08-138686 discloses a battery that uses a gasket made of tetrafluoroethylene-perfluoroalkyl vinyl ether copolymer resin (PFA), a separator made of glass fibers, and an electrolyte including an organic solvent with a boiling point of 170° C. or more. Polypropylene (PP) is conventionally used for a gasket, but when it is exposed to temperatures of higher than 60° C. for an extended period of time, the resin itself deteriorates and the sealing performance lowers. As a result, through sealed portions that have come loose, moisture enters to cause a capacity loss, or the electrolyte evaporates to cause a reliability degradation. In a severe case, the electrolyte leaks to damage the device. Hence, changing the gasket material to PFA reduces thermal shock and improves high-temperature storage characteristic.

The metals used in the negative electrode such as lithium and sodium and alloys thereof have very high reactivity. Also, there is no appropriate binder. It is thus difficult to use a powder with a large specific surface area, so a sheet-like material is used. However, when a sheet-like material is used in the negative electrode, the effective reaction area becomes small. As a result, the high-load discharge performance lowers.

Japanese Laid-Open Patent Publication No. 2002-117841 discloses a battery that utilizes a negative electrode made of an oxide, which is stable with respect to electrolyte, in combination with a gasket made of PFA having a heat deformation temperature of 230° C. or more. This battery does not rapidly swell even at reflow temperatures of 230° C. or more, nor do the gasket, the case, and the sealing plate become disengaged. In addition, even when this battery is stored after the reflowing, it is free from such problems as electrolyte leakage due to deformation of the gasket.

However, when this battery is exposed to a hot and humid environment during actual use, the sealing plate and the gasket become disengaged with the crimped portion of the case (hereinafter referred to as “the sealing members become disengaged”). When the gasket is made of fluorocarbon resin, moisture enters through the areas of the crimp-sealed portion with low gas tightness, although moisture enters slowly in comparison with PP. The moisture violently reacts with the negative electrode to produce hydrogen gas. The produced gas increases the internal pressure, thereby compressing the gasket and enhancing the gas tightness. When the internal pressure rises to or above the pressure the sealed portion can withstand, the sealing members become disengaged. Contrary to this, in the case of conventional PP gaskets, which have low heat resistance, the sealing members do not become disengaged since the internal pressure lowers due to electrolyte leakage or the like.

When the negative electrode is made of lithium or an alloy thereof, it reacts with moisture in air, so the lithium surface is inherently covered with lithium hydroxide, lithium carbonate, or the like. Thus, the aforementioned violent reaction does not occur. However, if the negative electrode is composed of a powder of an oxide or the like, the surface does not have such a coating film or the like and, in addition, the specific surface area is large, so the reactivity with moisture is high compared with lithium metal. Hence, the aforementioned violent reaction occurs.

In order to lower the reactivity between the negative electrode using an oxide and moisture, it is important to examine the PFA gasket. However, the PFA gasket has not been fully examined.

### DISCLOSURE OF THE INVENTION

A flat organic electrolyte secondary battery of the invention includes a negative electrode, a positive electrode, an organic electrolyte, a separator, a sealing plate, a positive electrode can, and a gasket. The negative electrode includes an oxide capable of reversibly absorbing and desorbing lithium ions as a negative electrode active material. The positive electrode is also capable of reversibly absorbing and desorbing lithium ions. The separator is interposed between the negative electrode and the positive electrode. The sealing plate is in contact with the negative electrode and serves as a negative electrode terminal. The positive electrode can is in contact with the positive electrode and serves as a positive electrode terminal. The gasket is interposed between the positive electrode can and the sealing plate. The gasket is composed of tetrafluoroethylene-perfluoroalkyl vinyl ether copolymer resin having a heat deformation temperature of 70° C. or more at a load of 0.45 MPa and a heat deformation temperature of 60° C. or less at a load of 1.82 MPa. This configuration can provide a flat organic electrolyte secondary battery that is excellent in high-load discharge performance and heat resistance and is highly safe so that when the internal pressure of the battery rises, the sealing members do not become disengaged and the internal pressure lowers (hereinafter referred to as “soft vent”).

### BRIEF DESCRIPTION OF THE DRAWING

FIG. 1 is a cross-sectional view of a flat organic electrolyte secondary battery in an embodiment of the invention.

### DESCRIPTION OF REFERENCE NUMERALS

1 Positive electrode can
2 Sealing plate
3 Gasket
4 Positive electrode
5 Negative electrode
6 Separator

### BEST MODE FOR CARRYING OUT THE INVENTION

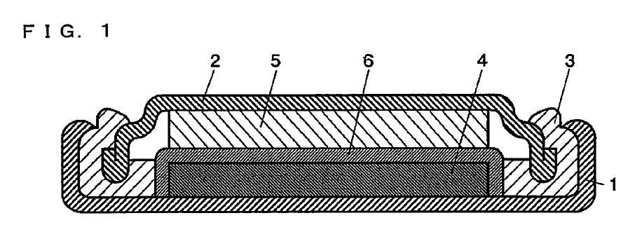

FIG. 1 is a cross-sectional view of a flat organic electrolyte secondary battery in an embodiment of the invention. This battery has a positive electrode 4 placed in a positive electrode can 1 with an open top, a negative electrode 5, a separator 6 interposed between the positive and negative electrodes for retaining an organic electrolyte (not shown), and a sealing plate 2. The sealing plate 2 is combined with the positive electrode can 1 with a gasket 3 made of tetrafluoroethylene-perfluoroalkyl vinyl ether copolymer resin (PFA) interposed therebetween. The opening of the positive electrode can 1 is crimped inward onto the sealing plate 2 to provide a seal. The positive electrode can 1 is in contact with the positive electrode 4 and serves as the positive electrode terminal, while the sealing plate 2 is in contact with the negative electrode 5 and serves as the negative electrode terminal.

The negative electrode 5 is formed by using an oxide capable of reversibly absorbing and desorbing lithium ions as the active material. The heat deformation temperature of the PFA resin of the gasket 3 is 95° C. at a load of 0.45 MPa and 58° C. at a load of 1.82 MPa. The measurement method of the heat deformation temperature conforms to ASTM D648.

The heat deformation temperature of the PFA resin has a large effect on the sealed portion. That is, when using a gasket made of PFA having a heat deformation temperature of less than 60° C. at a load of 0.45 MPa, it is not possible to obtain resistance to heat of 60° C. or more. It is thus possible only to obtain sealing performance equivalent to that obtained from conventional PP. On the other hand, the use of a gasket made of PFA having a heat deformation temperature of 100° C. or more at a load of 1.82 MPa provides excessive sealing strength. Hence, when the negative electrode 5 using a moisture-sensitive oxide is used in a hot and humid environment, soft vent is not possible and the sealing members become disengaged vigorously. It is therefore preferable to use PFA resin whose heat deformation temperature is 70° C. or more at a load of 0.45 MPa and 60° C. or less at a load of 1.82 MPa as the gasket 3. In this case, good heat resistance can be obtained, and at the same time, when the pressure inside the battery rises, a function of soft vent can be realized before the sealing members become disengaged.

The heat deformation temperature is measured using a thick, large test piece. Thus, such heat deformation temperature is not directly correlated with the heat deformation temperature of the resin having the thickness of the gasket 3, but can be used as a reference indicative of a value of a physical property. The gasket 3 is thin with a thickness of 0.2 to 0.4 mm, and the value of heat deformation temperature, i.e., the value at a load of 0.45 MPa is believed to be applicable to the compression stress maintained for crimp-sealing.

Also, the value at a load of 1.82 MPa is thought to be related to the value of the upper-limit internal pressure the sealed portion can withstand. As the heat deformation temperature becomes higher, the sealing pressure becomes higher and the possibility that the sealing members may become disengaged increases. Therefore, the heat deformation temperatures at the two levels of load are preferably close to each other so that soft vent occurs before the sealing members become disengaged.

Also, the ratio of compression of the PFA gasket 3 satisfying the aforementioned heat deformation temperatures by the crimp-sealing (thickness ratio) is preferably in the range of 30 to 80% relative to before the compression. When the compression ratio is in this range, more stable long-term reliability can be obtained.

The specific surface area of the oxide used as the negative electrode active material, as determined by the BET method, is preferably 2 m²/g or more and 10 m²/g or less. The BET method is a method of determining specific surface area from the amount of nitrogen adsorption. When the specific surface area of the oxide used as the negative electrode active material is 2 m²/g or more, it is possible to obtain superior high-load discharge performance to that obtained from a lithium metal or lithium alloy sheet. Also, if the specific surface area is larger than 10 m²/g, the reactivity with organic electrolyte or moisture increases. It is therefore preferable, in terms of long-term reliability, that the specific surface area be 10 m²/g or less.

Further, the oxide used as the negative electrode active material is preferably at least one selected from lithium titanates Li₄Ti₅O₁₂ and Li₂Ti₃O₇ and niobium oxide (Nb₂O₅). With respect to the reactivity of the oxide, not only the specific surface area but also the potential at which it reacts with lithium is important. Examples of the oxide include SiO and SnO, which are reduced to metal by the reaction of lithium insertion/extraction to form an alloy, and Fe₂O₃, WO₂, Li₄Ti₅O₁₂, and Nb₂O₅, in which the valence of the metal element is changed by the reaction of lithium insertion/extraction. The reaction potentials of alloy-forming oxides such as SiO are close to lithium metal, and the reaction potentials of, for example, Fe₂O₃ and WO₂ are around +1.0 V versus lithium metal. On the other hand, for example, Li₄Ti₅O₁₂, Li₂Ti₃O₇, and Nb₂O₅ have reaction potentials of +1.5 V or more versus lithium metal, so they have low reactivity and are thus preferable.

The configuration of the flat organic electrolyte secondary battery is hereinafter described in detail.

The positive electrode 4 includes an active material for 3-V class secondary batteries such as vanadium pentoxide, molybdenum trioxide, or a lithium manganese composite oxide, or a lithium-containing active material for 4-V class secondary batteries such as lithium cobaltate (LiCoO₂), lithium nickelate, or spinel-type lithium manganate. That is, the positive electrode 4 is capable of reversibly absorbing and desorbing lithium ions.

The positive electrode 4 and the negative electrode 5 are prepared as follows. First, each of a positive electrode active material and a negative electrode active material is mixed and kneaded with a conductive agent and a binder to prepare a positive electrode mixture and a negative electrode mixture. Carbon black, acetylene black, or graphite is used as the conductive agent. Fluorocarbon resin, styrene butadiene rubber (SBR), ethylenepropylene-diene rubber (EPDM), or the like is used as the binder. Each of the positive electrode mixture and the negative electrode mixture is shaped under pressure into a porous pellet to prepare the positive electrode 4 and the negative electrode 5.

With respect to the combination of active materials for the positive electrode and the negative electrode, various combinations are possible. However, such oxides as vanadium pentoxide, molybdenum trioxide, and lithium manganese composite oxides do not contain a lithium ion that reversibly comes in and out. Thus, only when such an oxide is used for the positive electrode 4, it is necessary to chemically or electrochemically insert lithium into the oxide of the negative electrode 5 in a process of battery production. One simple method of lithium ion insertion is a method of joining lithium metal to the negative electrode 5 and electrochemically causing a short inside the battery.

The separator 6 can be made of a conventionally used material such as polyethylene, polypropylene, cellulose, an engineering plastic such as polyphenylene sulfide, or glass fiber.

Examples of solutes for the organic electrolyte include LiPF₆, LiBF₄, LiCOl₄, LiCF₃SO₃, LiAsF₆, LiN(CF₃SO₂)₂, LiN(C₂F₅SO₂)₂, and LiN(CF₃SO₂)(C₄F₉SO₂), and they can be used singly or in combination of two or more of them. Also, examples of solvents for the organic electrolyte include, but are not limited to, propylene carbonate, ethylene carbonate, butylene carbonate, vinylene carbonate, dimethyl carbonate, diethyl carbonate, sulfolane, dimethoxyethane, diethoxyethane, tetrahydrofuran, dioxolane, and γ-butyrolactone, and they can be used singly or in combination of two or more of them.

The above configuration can provide a flat organic electrolyte secondary battery that is excellent in high-load discharge performance and heat resistance and is highly safe so that when the internal pressure of the battery rises, the soft vent function is exhibited.

Using more concrete examples of batteries A to D, the effects of this embodiment are described. First, the configuration of the battery A is described.

LiCoO₂ was used as the active material of the positive electrode 4. This active material was mixed with a graphite conductive agent and a fluorocarbon resin binder in a weight ratio of 88:5:7 to prepare a positive electrode mixture. This positive electrode mixture of 260 mg was formed into a 16-mm diameter pellet under a pressure of 2 ton/cm², and dried at 200° C. in dry air to prepare the positive electrode 4.

Li₄Ti₅O₁₂ with a specific surface area of 3 m²/g was used as the active material of the negative electrode 5, and this was mixed with an acetylene black conductive agent and an SBR binder in a weight ratio of 88:5:7 to prepare a negative electrode mixture. This negative electrode mixture of 140 mg was formed into a 16-mm diameter pellet under a pressure of 2 ton/cm², and dried at 200° C. in dry air to prepare the negative electrode 5.

PFA resin was used as the material of the gasket 3. The heat deformation temperature of the PFA resin is 95° C. at a load of 0.45 MPa and 58° C. at a load of 1.82 MPa. The positive electrode can 1 and the sealing plate 2 were prepared from stainless steel. The separator 6 was made of a polypropylene non-woven fabric. The organic electrolyte was prepared by dissolving lithium hexafluorophosphate (LiPF₆) at 1 mol/l in ethylene carbonate (EC) and ethyl methyl carbonate (EMC).

This battery is assembled in the following procedure. First, the positive electrode 4 and the separator 6 are placed in the positive electrode can 1, into which the organic electrolyte is injected. Then, the negative electrode 5 is attached to the central part of the inner face of the sealing plate 2, and the sealing plate 2 is inserted into the positive electrode can 1. At this time, the power generating element, composed of the positive electrode 4 and the negative electrode 5 that face each other with the separator 6 interposed therebetween, is housed in the inner space of the battery container surrounded by the sealing plate 2 and the positive electrode can 1 which are insulated by the gasket 3. At this time, a sealant, made of butyl rubber that is formed by applying a solution prepared by diluting butyl rubber with toluene to the edge of the positive electrode can 1 and the gasket 3 and evaporating the toluene, is interposed between the positive electrode can 1 and the gasket 3 and between the sealing plate 2 and the gasket 3. Thereafter, the edge of the positive electrode can 1 is deformed inward by using a crimping tool and bent together with the gasket 3 along the circumference of the sealing plate 2. As a result, an inward crimp is formed on the positive electrode can 1, so that the circumference of the sealing plate 2 is squeezed by the crimp from upper and lower directions with the gasket 3 interposed therebetween. In this way, a battery of 20 mm in diameter and 2.0 mm in thickness having a cross-sectional shape as illustrated in FIG. 1 can be obtained.

The battery B was produced in the same manner as the battery A except for the use of the gasket 3 made of PFA resin whose heat deformation temperature was 70° C. at a load of 0.45 MPa and 43° C. at a load of 1.82 MPa. The battery C was produced in the same manner as the battery A except for the use of the gasket 3 made of PFA resin whose heat deformation temperature was 105° C. at a load of 0.45 MPa and 58° C. at a load of 1.82 MPa. The battery D was produced in the same manner as the battery A except for the use of the gasket 3 made of PFA resin whose heat deformation temperature was 70° C. at a load of 0.45 MPa and 60° C. at a load of 1.82 MPa.

Meanwhile, in order to make a comparison with these batteries, batteries P to S were produced. The battery P was produced in the same manner as the battery A except for the use of the gasket 3 made of PFA resin whose heat deformation temperature was 69° C. at a load of 0.45 MPa and 40° C. at a load of 1.82 MPa. The battery Q was produced in the same manner as the battery A except for the use of the gasket 3 made of PFA resin whose heat deformation temperature was 116° C. at a load of 0.45 MPa and 61° C. at a load of 1.82 MPa.

The battery R was produced in the same manner as the battery A except for the use of the gasket 3 made of PFA resin whose heat deformation temperature was 150° C. at a load of 0.45 MPa and 127° C. at a load of 1.82 MPa. The battery S was produced in the same manner as the battery A except for the use of the gasket 3 made of PFA resin whose heat deformation temperature was 230° C. at a load of 0.45 MPa and 200° C. at a load of 1.82 MPa.

These batteries were evaluated as follows. Of each kind, 10 batteries were charged to 3.0 V at a constant current of 1 mA. Thereafter, they were left in a hot and humid environment of 70° C./90% for 480 hours and observed to check if the sealing members became disengaged. Also, 10 batteries of each kind were charged to 3.0 V at a constant current of 1 mA and then subjected to a thermal shock test to examine their performance of resistance to electrolyte leakage. In the thermal shock test, a cycle of −10° C./60° C. was repeated 100 times, and each temperature of −10° C./60° C. was held for 1 hour. The results of the hot and humid environment test and the thermal shock test are shown in Table 1.

TABLE 1

| | | | Disengagement of | Electrolyte |
|---|---|---|---|---|
| | Heat deformation | | sealing member in | leakage in |
| | temperature of PFA | | hot and humid | thermal |
| | (° C.) | | environment test | shock test |
| Battery | 0.45 MPa | 1.82 MPa | (per 10) | (per 10) |
| A | 95 | 58 | 0 | 0 |
| B | 70 | 43 | 0 | 0 |
| C | 105 | 58 | 0 | 0 |
| D | 70 | 60 | 0 | 0 |
| P | 69 | 40 | 0 | 3 |
| Q | 116 | 61 | 2 | 0 |
| R | 150 | 127 | 4 | 0 |
| S | 230 | 200 | 10 | 0 |

With respect to the batteries A to D, the sealing members did not become disengaged in the humid environment test, nor was electrolyte leakage or the like observed in the thermal shock test. On the other hand, as for the batteries Q to S, no electrolyte leakage was observed in the thermal shock test, but the disengagement of the sealing members was observed in the humid environment test since the sealing strength of the gasket 3 was excessive and soft vent was thus not possible. In particular, as the heat deformation temperature became higher, the incidence of the disengagement of the sealing members increased.

Also, in the case of the battery P with low heat deformation temperatures, the disengagement of the sealing members was not observed in the humid environment test, but electrolyte leakage was observed in the thermal shock test since the gas tightness of the sealed portion was lost due to the deformation of the gasket 3.

Next, the use of different oxides in the negative electrode 5 is described with reference to the aforementioned battery A and the following batteries E to K. The battery E was prepared in the same manner as the battery A except for the use of Li₄Ti₅O₁₂ with a specific surface area of 2 m²/g in the negative electrode 5. The battery F was produced in the same manner as the battery A except for the use of Li₄Ti₅O₁₂ with a specific surface area of 10 m²/g in the negative electrode 5. The battery G was prepared in the same manner as the battery A except for the use of Li₂Ti₃O₇ with a specific surface area of 3 m²/g in the negative electrode 5.

The battery H was prepared in the same manner as the battery A except for the use of Nb₂O₅ with a specific surface area of 3 m²/g in the negative electrode 5. The battery J was prepared in the same manner as the battery A except for the use of Li₄Ti₅O₁₂ with a specific surface area of 12 m²/g in the negative electrode 5. The battery K was prepared in the same manner as the battery A except for the use of Li₄Ti₅O₁₂ with a specific surface area of 15 m²/g in the negative electrode 5. The battery L was prepared in the same manner as the battery A except for the use of Li₄Ti₅O₁₂ with a specific surface area of 1 m²/g in the negative electrode 5.

With respect to each of the batteries A, E, F, G, H, J, K, and L, 10 batteries were subjected to a hot and humid environment test in the same manner as described above. Also, before and after the hot and humid environment test, they were discharged at a constant current of 1 mA to measure the discharge capacity (1.5 V cut-off). With the average value of the discharge capacity of the battery A before the test being defined as 100, the ratio of the average value of the discharge capacity after the test was calculated. The results are shown in Table 2.

TABLE 2

| | | | Disengagement | | Ratio of |
|---|---|---|---|---|---|
| | | | of sealing | Ratio of | discharge |
| | Negative | Specific | member in | initial | capacity |
| | electrode | surface | hot and humid | discharge | after hot |
| | active | area | environment test | capacity | and humid |
| Battery | material | (m²/g) | (per 10) | (%) | (%) |
| A | Li₄Ti₅O₁₂ | 3 | 0 | 100 | 84 |
| E | Li₄Ti₅O₁₂ | 2 | 0 | 100 | 87 |
| F | Li₄Ti₅O₁₂ | 10 | 0 | 100 | 79 |
| G | Li₂Ti₃O₇ | 3 | 0 | 100 | 82 |
| H | Nb₂O₅ | 3 | 0 | 100 | 85 |
| J | Li₄Ti₅O₁₂ | 12 | 0 | 100 | 65 |
| K | Li₄Ti₅O₁₂ | 15 | 0 | 100 | 50 |
| L | Li₄Ti₅O₁₂ | 1 | 0 | 72 | 63 |

In the results of Table 2, the disengagement of the sealing members was not found in any of the batteries in the hot and humid environment test. However, the battery L with a low specific surface area appears to have a small initial discharge performance. In this way, the capacity was small although the deterioration in the hot and humid environment test was small. This is because the small specific surface area of the negative electrode active material results in a high internal resistance and a poor load characteristic. Also, in the batteries J and K whose negative electrode active materials have a large specific surface area, the capacity deterioration in the humid environment was relatively large after the test. These results indicate that the specific surface area of the negative electrode active material is preferably 2 m²/g or more and 10 m²/g or less.

### INDUSTRIAL APPLICABILITY

The flat organic electrolyte secondary battery according to the invention is applicable to uses involving exposure to a hot and humid environment, such as measurement of air pressure in a tire, and its industrial value is very high.

1. A flat organic electrolyte secondary battery comprising:
a negative electrode including an oxide capable of reversibly absorbing and desorbing lithium ions as a negative electrode active material;
a positive electrode capable of reversibly absorbing and desorbing lithium ions;
an organic electrolyte;
a separator interposed between said negative electrode and said positive electrode;
a sealing plate in contact with said negative electrode, said sealing plate serving as a negative electrode terminal;
a positive electrode can in contact with said positive electrode, said positive electrode can serving as a positive electrode terminal; and
a gasket interposed between said positive electrode can and said sealing plate, said gasket comprising tetrafluoroethylene-perfluoroalkyl vinyl ether copolymer resin having a heat deformation temperature of 70° C. or more at a load of 0.45 MPa and a heat deformation temperature of 60° C. or less at a load of 1.82 MPa.

2. The flat organic electrolyte secondary battery in accordance with claim 1, wherein said oxide has a specific surface area of 2 m²/g or more and 10 m²/g or less, said specific surface area being determined by the BET method.

3. The flat organic electrolyte secondary battery in accordance with claim 1, wherein said oxide includes at least one of Li₄Ti₅O₁₂, Li₂Ti₃O₇, and Nb₂O₅.
